(19) United States
(12) Patent Application Publication
(10) Pub. No.: US 2009/0236420 A1
(43) Pub. Date: Sep. 24, 2009

(54) SMART SHELF TOTE DEVICE FOR MULTIPLE DIFFERENT PRODUCTS

(75) Inventor: Michael G. LONDO, Wake Forest, NC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Glen Allen, VA (US)

(21) Appl. No.: 12/113,435

(22) Filed: May 1, 2008

Related U.S. Application Data
(60) Provisional application No. 61/037,454, filed on Mar. 18, 2008.

(51) Int. Cl. G06F 19/00

(52) U.S. Cl. 235/385

(57) ABSTRACT

Disclosed is a smart shelf tote device for holding different products that is capable of distinguishing from among the different products. The device is adapted to receive products within individual seating areas. Conductive ink traces are associated with each of the seating areas. An electronics component includes a conductive ink trace interface that is coupled with conductive ink traces associated with each of the seating areas. There is also a memory component for storing unique circuit load characteristic profiles wherein each profile is associated with a different product. A software component recognizes a unique circuit load characteristic profile when a product that includes a unique conductive ink trace that is coupled with the partially exposed conductive ink traces is seated within one of the seating areas. Input/output devices can then provide an audio/video presentation of products upon sensing the removal of a specific product from its seating area.

### CROSS-REFERENCE TO RELATED APPLICATIONS

This application is related to and claims the priority filing benefit of U.S. Provisional Patent Application No. 61/037,454 filed on Mar. 18, 2008 and entitled, “Smart Shelf Tote Device For Multiple Different Products”.

### BACKGROUND OF THE INVENTION

Smart shelf tote devices provide the consumer with an interactive information dispensing environment when selecting a certain product. This environment can be enhanced with visual and/or audio cues. For example, when a consumer removes a product unit from a smart shelf tote device he or she is prompted to participate further in the product selection and/or presented with audio/visual information about the selected product. These designs use technologies to identify when a product unit has been removed from its shelf location.

Such smart shelf tote devices are designed for displaying many packages but all of the same type (i.e., a single SKU or UPC). A stock keeping unit (SKU) and a universal product code (UPC) are unique product identifiers that can be printed or otherwise affixed on product packaging or otherwise associated with a product via, for instance, a bar code label or RFID tag. While the configuration of the product display can be varied, all positions within the shelf hold the same product. Therefore, it does not matter what “position” from which a product package is selected. Conversely it does not matter what “position” the consumer selects to return the package if the consumer decides not to purchase a product.

To date, a smart shelf tote device has not been designed to work with multiple different products.

What is needed is a smart shelf tote device that can distinguish and handle multiple different products that are seated within the same device.

### SUMMARY OF THE INVENTION

A smart shelf tote device for holding one or more different product units that is capable of distinguishing from among the one or more different product units. The smart shelf tote device is adapted to receive one or more individual products within individual seating areas. One or more conductive ink traces are associated with each of the individual seating areas.

An electronics component includes a conductive ink trace interface that is coupled with conductive ink traces associated with each of the individual seating areas. There is also a memory component for storing unique circuit load characteristic profiles wherein each unique circuit load characteristic profile is associated with a different product. The memory also stores consumer information pertaining to each different product.

A software component recognizes a unique circuit load characteristic profile when a product unit that includes a unique conductive ink trace that is in contact with the partially exposed one or more conductive ink traces is seated within one of the seating areas.

Input/output (I/O) devices can then provide an audio and/or video presentation associated with a specific product upon sensing the removal of that specific product from its seating area.

### BRIEF DESCRIPTION OF THE DRAWINGS

FIG. 1 illustrates one embodiment of a smart shelf tote device capable of distinguishing from among different products.

FIG. 2 illustrates one example of a conductive ink trace pattern that can be applied to the packaging of a product unit.

FIG. 3 illustrates another example of a conductive ink trace pattern that can be applied to the packaging of a product unit.

FIG. 4 illustrates yet another example of a conductive ink trace pattern that can be applied to the packaging of a product unit.

FIG. 5 illustrates a logic diagram that describes a process of recognizing when a specific product unit within a shelf tote device has been removed by a consumer.

### DETAILED DESCRIPTION OF THE EMBODIMENTS

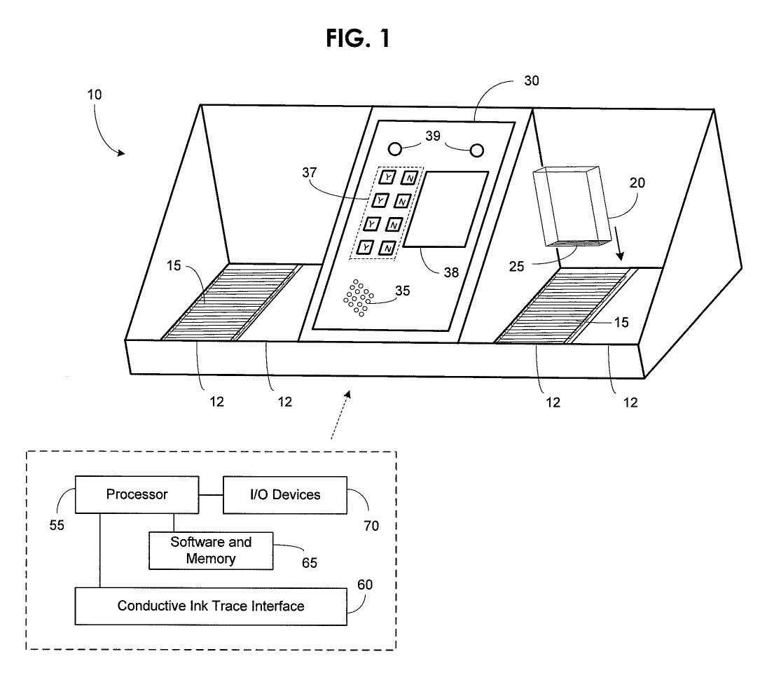

Referring to FIG. 1, an example smart shelf tote device 10 is shown that can accommodate four columns 12 of product units 20 wherein a product unit 20 is associated with a product. In this example, each column 12 can hold approximately ten individual product units 20 yielding a total of forty product units. The product units 20 do not necessarily need to be of the same type to work with smart shelf tote device 10. That is, the smart shelf tote device 10 can individually recognize a product based on a unique conductive ink trace 25 design affixed to the product's packaging. The conductive ink trace 25 interacts with corresponding conductive ink traces 15 printed on the smart shelf tote device 10 in the area where the product units 20 are seated to form a circuit with unique load characteristics.

The conductive ink traces 15 located in the seating areas of the smart shelf tote device 10 are coupled with a conductive ink trace interface 60 within a housing of the smart shelf tote device 10. The conductive ink trace interface 60 is coupled with a processor 55 that is further coupled with software/memory 65 and one or more I/O devices 70.

The smart shelf tote device 10 can also include an interactive interface 30 that allows a user to request additional information for a chosen product unit 20 or to receive information as a result of removing the product unit 20 from its seated location in the smart shelf tote device 10. The interactive interface 30 can include I/O devices such as a speaker 35, questionnaire buttons 37, a display 38, or visual indicators 39.

In one embodiment, the speaker 35 can be of a coneless variety comprised of an exciter that works when a transducer vibrates a lightweight stiff substrate in such a manner as to produce audio.

Conductive ink traces 15, 25 are printed on both the product unit 20 and the smart shelf tote device 10. The product unit 20 is then mechanically and electrically coupled with the smart shelf tote device 10 when it is seated in one of the seating areas on the smart shelf tote device 10. When seated the product 20 and the smart shelf tote device 10 form a circuit having unique resistance or load characteristics that depend on the specific coupling of the conductive ink traces 15, 25 between the product unit 20 and the smart shelf tote device 10. These characteristics are known to the software/memory 65 within the smart shelf tote device 10 and associated with a specific product. When a product unit 20 is removed, that unique circuit is broken. This absence is recognized and quantified by the processor 55 and the software 65. The smart shelf tote device 10 thus recognizes the event of a product unit 20 being removed from the smart shelf tote device 10 and is also able to determine which product has been removed based on the absence of particular circuit characteristics. This information can then be used to launch an audio and/or video presentation to the consumer that provides more information on the product they have just selected.

If the consumer decides to replace the product unit 20 within the smart shelf tote device 10, it does not matter where (e.g., which slot) the consumer returns the product unit 20 since it will create the same unique circuit characteristics regardless of the slot that is used. Thus, the system is not dependent on the consumer returning the product unit 20 to the same location from whence it came. The next consumer to select that product unit 20 will receive the same response as the previous consumer.

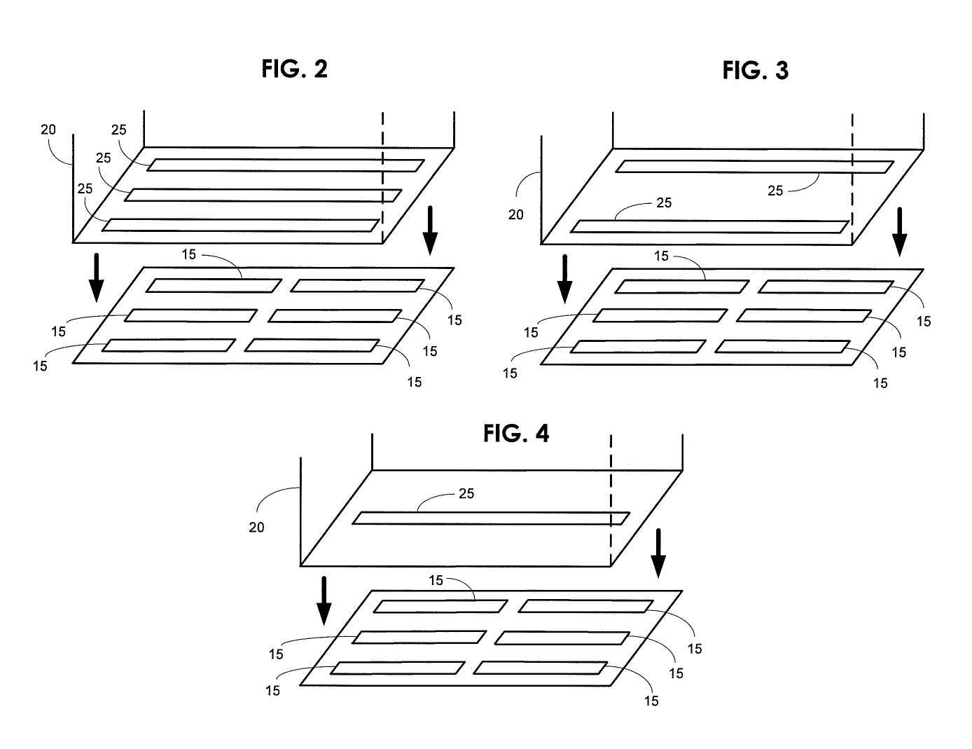

FIG. 2 illustrates one example of a conductive ink trace pattern that can be applied to the packaging of a product unit 20. In this example, the seating area on the smart shelf tote device 10 is printed with three conductive ink traces 15. Each of these traces is coupled with the conductive ink trace interface 60 to create a circuit with the processor 55 and software 65 within the smart shelf tote device 10. A bottom cut-away portion of product unit 20 is shown with its own pattern of conductive ink traces 25. In this example, there are three conductive ink traces 25 that will contact corresponding conductive ink traces 15 in the seating area when the product unit 20 is mechanically seated within the smart shelf tote device 10. The pattern of conductive ink traces 25 on the product unit 20 will create a circuit having unique load or resistance characteristics. In this example, three circuits are created. The unique load characteristics can be quantified by summing the resistance exhibited in each circuit. The conductive ink traces 25 can utilize inks of varying conductivity/resistivity to create unique and identifiable circuit characteristics.

FIG. 3 illustrates another example of a conductive ink trace pattern that can be applied to the packaging of a product unit 20. In this example, there are two conductive ink traces 25 that will contact corresponding conductive ink traces 15 in the seating area when the product unit 20 is mechanically seated within the smart shelf tote device 10. This pattern of conductive ink traces 25 on the product unit 20 will create a circuit having unique load or resistance characteristics. In this example, two circuits are created. The unique load characteristics can be quantified by summing the resistance exhibited in each circuit. Since this example creates two circuits (as opposed to three in FIG. 2) it will have different load characteristics that distinguish it from the example of FIG. 2.

FIG. 4 illustrates yet another example of a conductive ink trace pattern that can be applied to the packaging of a product unit 20. In this example, there is only one conductive ink trace 25 that will contact a corresponding conductive ink trace 15 in the seating area when the product unit 20 is mechanically seated within the smart shelf tote device 10. This pattern of conductive ink traces 25 on the product 20 will also create a circuit having unique load or resistance characteristics. In this example, only one circuit is created. The unique load characteristics can be quantified by summing the resistance exhibited in the circuit. Since this example creates only one circuit (as opposed to three in FIG. 2 and two in FIG. 3) it will have different load characteristics that distinguish it from the examples of FIG. 2 and FIG. 3.

The examples above are not exhaustive. Those of ordinary skill in the art can readily create multiple different conductive ink trace designs each with unique characteristics. For instance, the conductive ink traces 25 can utilize higher resistance inks for one class of product than for another class of products. Thus, the ink itself can be a determining factor along with the pattern or design of the conductive ink traces 25.

In addition, the conductive ink traces 25 can be pre-printed on a label and then adhered to the product packaging rather than being printed directly on the product packaging.

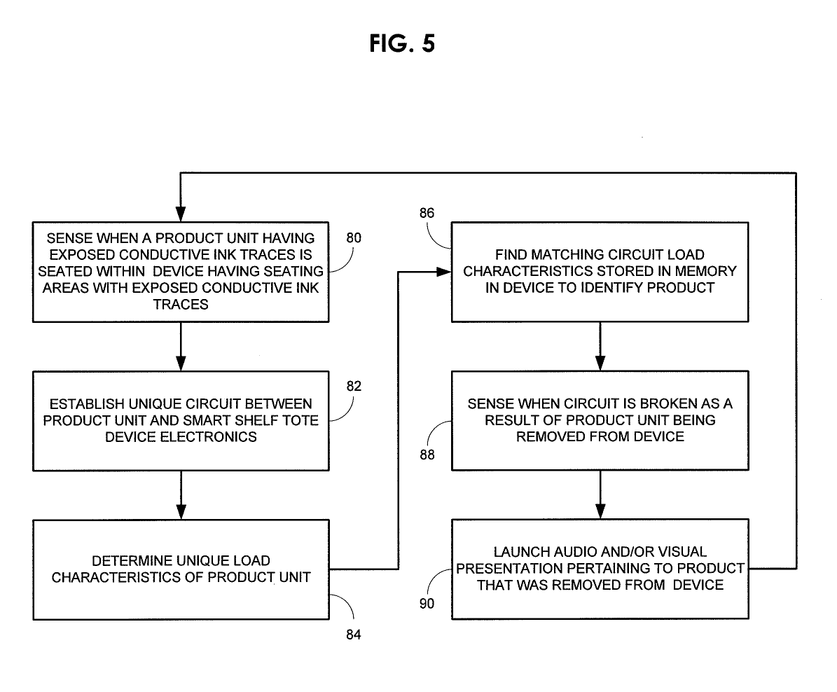

FIG. 5 illustrates a logic diagram that describes a process of recognizing when a specific product unit within a shelf tote device has been removed by a consumer. The smart shelf tote device senses when a product unit having exposed conductive ink traces is seated within the smart shelf tote device 80. The conductive ink traces on the product unit establish a unique circuit between the product unit and the smart shelf tote device 82. The smart shelf tote device then determines the unique load characteristics of the circuit created by the coupling of the product unit with the smart shelf tote device 84. The smart shelf tote device searches its memory to find a matching circuit load characteristic profile that is linked with information pertaining to that product 86. The smart shelf tote device then waits and senses when a product unit has been removed (i.e., a specific circuit is broken) from a seating location 88. The smart shelf tote device then launches and audio and/or video presentation that is designed to provide more consumer information about the product unit that was just removed 90.

The audio and/or video presentation can be interactive in that it can query the consumer for responses that can be input using an interface on the smart shelf tote device. For instance, the smart shelf tote device can ask, “If you would you like to hear more about this product, press the green button”. If the consumer presses the green button the presentation commences. Otherwise, the smart shelf tote device can remain silent. In another example, the presentation can comprise a series of yes/no type questions that are displayed on a display that the consumer can respond to that will elicit a customized response from the smart shelf tote device.

The consumer can replace the product unit within the smart shelf tote device at any point. If the presentation has not completed, the act of replacing the product unit could serve to terminate the presentation.

One of the features of an embodiment of the invention is that the consumer need not return the product unit to the exact same location from whence it came. The smart shelf tote device does not distinguish products by what location where they were originally placed. Rather, the smart shelf tote device determines what product is in a particular location based on the circuit characteristics it creates when it is seated within the smart shelf tote device. Thus, moving a product unit from one location within the smart shelf tote device to another location within the smart shelf tote device will not affect the smart shelf tote device's ability to recognize and identify different products.

It is believed that the present invention includes many other embodiments that may not be herein described in detail, but would nonetheless be appreciated by those skilled in the art from the disclosures made. Accordingly, this disclosure should not be read as being limited only to the foregoing examples or only to the designated preferred embodiments.

1. A device for holding one or more units of different products that is capable of distinguishing from among the different products, the device comprising:
a housing adapted to receive the one or more units of differing products within individual seating areas, wherein different products have their own unique first conductive ink trace associated therewith;
one or more second conductive ink traces associated with each of the individual seating areas wherein the one or more second conductive ink traces are at least partially externally exposed within each individual seating area; and
an electronics component coupled with the one or more second conductive ink traces, wherein the electronics component identifies a product when a product unit containing a first conductive ink trace unique to a product is seated within an individual seating area such that the first conductive ink trace on the product unit is coupled with one of the second conductive ink traces within one of the individual seating areas.

2. The device of claim 1 wherein the electronics component includes:
a processor;
a conductive ink trace interface coupled with the processor and further coupled with second conductive ink traces within each of the individual seating areas;
a memory component coupled with the processor for storing:
one or more unique circuit load characteristic profiles wherein each unique circuit load characteristic profile is associated with a different product; and
consumer information pertaining to each different product,
a software component coupled with the processor that can identify a unique circuit load characteristic profile when a product unit that includes a first unique conductive ink trace is in contact with one of the partially exposed one or more second conductive ink traces; and
one or more input/output (I/O) devices coupled with the processor that can provide an audio and/or video presentation using the consumer information associated with a specific product upon sensing the removal of a product unit for that specific product from its seating area.

3. The device of claim 1 wherein the conductive ink used for the exposed unique first conductive ink traces can have varying conductivity and/or resistivity properties.

4. The device of claim 1 wherein one of the I/O devices is a speaker.

5. The device of claim 1 wherein the speaker is comprised of an exciter.

6. The device of claim 1 wherein one of the I/O devices is a video display.

7. A packaged product unit capable of being seated within an individual seating area of a device wherein the device includes partially exposed first conductive ink traces in the individual seating area, the packaged product unit comprising:
an exposed unique conductive ink trace pattern on its packaging such that when the packaged product unit is seated within the individual seating area of the device, a circuit having unique load characteristics is created by the partially exposed first conductive ink traces contacting the exposed unique conductive ink trace pattern on the product unit's packaging.

8. The packaged product unit of claim 7 wherein the exposed unique conductive ink traces are printed directly on the product packaging.

9. The packaged product unit of claim 7 wherein the exposed unique conductive ink traces are printed on a label that can be affixed to the product packaging.

10. The packaged product unit of claim 7 wherein the conductive ink used for the exposed unique conductive ink traces can have varying conductivity and/or resistivity properties.

11. A method of presenting consumer information pertaining to a product unit when it is removed from a device, the method comprising:
creating a circuit having unique circuit load characteristics when the product unit is seated within a device;
associating the unique circuit load characteristics of the product unit with consumer information for a specific product;
sensing when the product unit has been removed from its seated location within the device;
causing an audio or video presentation of consumer information pertaining to the product that has been removed to commence.

12. The method of claim 11 further comprising terminating the audio or video presentation of consumer information pertaining to the product if the product unit is returned to any seated area within the device.
